(19) United States
(12) Patent Application Publication
(10) Pub. No.: US 2016/0103568 A1
(43) Pub. Date: Apr. 14, 2016

(54) E-MENU SERVICE METHOD USING WEB EDITOR AND SYSTEM THEREFOR

(71) Applicant: Man Bong LEE, Gyeonggi-do (KR)

(72) Inventor: Man Bong LEE, Seongnam (KR)

(21) Appl. No.: 14/889,444

(22) PCT Filed: May 7, 2014
(86) PCT No.: PCT/KR2014/004021

§ 371 Date: Nov. 6, 2015

(30) Foreign Application Priority Data
May 28, 2013 (KR) 10-2013-0060491

(51) Int. Cl. G06F 3/0482; G06F 3/0484

(52) U.S. Cl. CPC G06F 3/0482; G06F 3/04845

(57) ABSTRACT

Disclosed herein is an electronic menu book service method using a web editor, including: (a) configuring, by the web editor of a web server, an application menu page on a web editor screen; (b) installing, by a user device, a menu book application thereat; (c) accessing, by the user device, the web server and downloading configuration information on a menu page configured on the web; and (d) using, by the user device, the menu book application including the configuration information. According to an exemplary embodiment of the present invention, it is possible to enable a user to configure an application in a DIY (do it yourself) manner with a web editor on the web and to download and use the configured application information.

### CROSS-REFERENCE TO RELATED APPLICATION

This application claims priority to and the benefit of Korean Patent Application No. 10-2013-0060491 filed in the Korean Intellectual Property Office on May 28, 2013, the entire contents of which are incorporated herein by reference.

### BACKGROUND OF THE INVENTION

(a) Field of the Invention

The present invention relates to an electronic menu book service method using a web editor, and a system therefor. More particularly, the present invention relates to an electronic menu book service method using a web editor and a system therefor that enable a user to configure an application in a DIY (do it yourself) manner with a web editor on the web and to download and use the configured application information.

(b) Description of the Related Art

In general, an electronic menu book (e-menu book), which is regarded as a customized solution of the next generation, is a system in which an employee at a shop can provide menu information of the shop via a mobile device, and a customer himself/herself may place an order via a terminal.

A conventional art with respect to an electronic menu book is disclosed in [Patent Document 1], Korean Patent Laid-Open Publication No. 10-2010-0133533 (Published on Dec. 22, 2010) and [Patent Document 2], Korean Patent No. 10-1008588 (Registered on Jan. 14, 2011).

[Patent Document 1] includes: a menu terminal that is installed at the service shop in plural, and provides detailed information on menu items of the service, the respective menu items via an output device, and an optional item with respect to the service item selected by a customer among the menu items; and a receipt terminal in which a network is established with the menu terminal, and the service item and the optional item transmitted from the menu terminal are outputted. Accordingly, the electronic menu system of [Patent Document 1] has advantages of solving difficulties in communication, providing various information on the menu items, configuring a menu with a variety of patterns, accumulating revenue of the shop in real time for the practical use of management data, and sharing the data-based electronic menu book via a server as information on the management data of the related shops.

In addition, [Patent Document 2] includes a main server, a client PC of a restaurant, and an electronic menu book. Further, [Patent Document 2] may simply provide the electronic menu book at the restaurant with a low cost, and may easily reconfigure the menu book when the menu is required to be modified. Particularly, a misspelled word of a food description on the electronic menu book may be prevented. Additionally, the food ordering system using the electronic menu book allows to readily make and update the menu of the electronic menu book at the subscriber restaurant, and to provide unified food information with various languages to the restaurant, thereby preventing the misspelled word of the food description on the electronic menu book.

However, since the conventional art described above only performs an uploading process in a predetermined formation on a simple template provided from a website (required factors for a corresponding page may be selected from an image upload, text, and a predetermined list), a user may not easily configure it with his/her own ideas. Further, it may be difficult for the user to predict what kind of result will be created before confirming it by downloading data via an application.

Furthermore, in the case of the conventional art, a new application is required to be developed in order to newly modify the electronic menu book, which results in a drawback that a production period is further extended and a production cost is high, thereby causing a limiting factor with respect to a modification of the electronic menu book.

### RELATED ART DOCUMENTS

### Patent Document

[Patent Document 1] Korean Patent Laid-Open Publication No. 10-2010-0133533 (Published on Dec. 22, 2010) po [Patent Document 2] Korean Patent No. 10-1008558 (Registered on Jan. 14, 2011)

The above information disclosed in this Background section is only to enhance the understanding of the background of the invention and therefore it may contain information that does not form the prior art that is already known in this country to a person of ordinary skill in the art.

### SUMMARY OF THE INVENTION

The present invention has been made in an effort to provide an electronic menu book service method using a web editor and a system therefor that enable a user to configure an application in a DIY (do it yourself) manner with a web editor on the Web and to download and use the configured application information.

The present invention has been further made in an effort to provide an electronic menu book service method using a web editor and a system therefor which enables a user to interactively confirm his/her desired menu book on the Web in real time.

Additionally, the present invention has been made in an effort to provide an electronic menu book service method using a web editor and a system therefor which enables a user to dispose menus and properties by directly using a mouse, thereby providing the user with intuitive and various interfaces.

An exemplary embodiment of the present invention provides an electronic menu book service method using a web editor, including: (a) configuring, by a web editor of the web server, an application menu page on a web editor screen; (b) installing, by a user device, a menu book application thereat; (c) accessing, by the user device, the web server and downloading configuration information on a menu page configured on the web; and (d) using, by the user device, the menu book application including the configuration information.

The step (a) may include: (a-1) selecting a template for configuring the menu page; (a-2) configuring the menu page on the selected template or a non-set initial screen; and (a-3) confirming the configured menu page through a preview function of a menu book.

The step (a-2) may include: configuring menus; selecting an image and a color of a background screen; adding a function; inserting an image for the menu; inputting a description on the menu; determining a font position of the description; and inputting order-related information.

The web editing screen may include a writing information and classification area for confirming writing information and classification, an input property appointing and editing area for appointing and editing input properties, a writing main utility area for supporting tools for the writing, a display preview area for previewing the configured menu page, and a menu display editing area for editing the menu.

The electronic menu book service method using the web editor may further include: (e) transmitting, by the user device, order data of a customer to a terminal located at a shop; and (f) storing, by the user device, the order data of the customer in the web server.

Another embodiment of the present invention provides an electronic menu book service system using a web editor, including: a web server in which an application menu page is configured to be stored with a web editor for configuring a menu when a user accesses the web server via a network, and that downloads configuration information of a menu page to a user device when the user logs in; and a user device in which a menu book application is downloaded and installed by the web server and a market platform connected to the network, and that receives configuration information of a menu book from the web server and displays the menu book on a screen.

The web editor may display a web editing screen for configuring the menu page on a browser of the user device, and may include a menu page configuration unit that configures the menu page in accordance with information that a user inputs with an input device.

The menu page configuration unit may provide a template for configuring the menu book, configure the menu page in accordance with an operation of the user, and display the configured menu page on the screen when the menu book application is executed.

The web editor may include a configuration information storage that stores the configuration information on the menu page, and a downloader that enables the configuration information stored in the configuration information storage to be downloaded to the user device connected online.

The web editor may include a use data storage that stores use data transmitted from the user device and provides the use data in a form of statistical data.

According to the embodiments of the present invention, the user may implement an application in the DIY (do it yourself) manner by using the web editor on the Web and may download and use the corresponding configuration information, thereby having an effect of accelerating implementation of user's electronic menu book.

In addition, according to the embodiments of the present invention, it is possible to confirm the desired menu book on the web in real time through the interactive action.

Further, according to the embodiments of the present invention, it is possible to dispose menus and properties by directly using a mouse, thereby having an effect of providing the user with the intuitive and further various interfaces.

Further, according to the embodiments of the present invention, since the electronic menu book is variously configured on the web in real time through the web editor, the new application is not required to be produced when the electronic menu book needs to be newly modified, thereby having advantages of saving costs for producing the application, and of shortening the process from the time the menu information needs to be modified until the time the modified menu information is provided to the customer.

### BRIEF DESCRIPTION OF THE DRAWINGS

FIG. 1 illustrates a block diagram of an electronic menu book service system using a web editor according to an exemplary embodiment of the present invention.

FIG.2 illustrates an exemplary block diagram of the web editor of FIG. 1.

FIG. 3 illustrates an exemplary schematic diagram of a web editor screen applied to an exemplary embodiment of the present invention.

FIG. 4 illustrates a flowchart of an electronic menu book service method of using a web editor according to an exemplary embodiment of the present invention.

FIG. 5 illustrates an exemplary flowchart of a configuration process of a menu page of FIG. 4.

FIGS. 6A and 6B illustrate webpage draft screens according to an exemplary embodiment of the present invention.

### DETAILED DESCRIPTION OF THE EMBODIMENTS

An electronic menu book (e-menu book) service method using a web editor and a system therefor according to an exemplary embodiment of the present invention will now be described in detail with reference to the accompanying drawings.

### Exemplary Embodiment 1

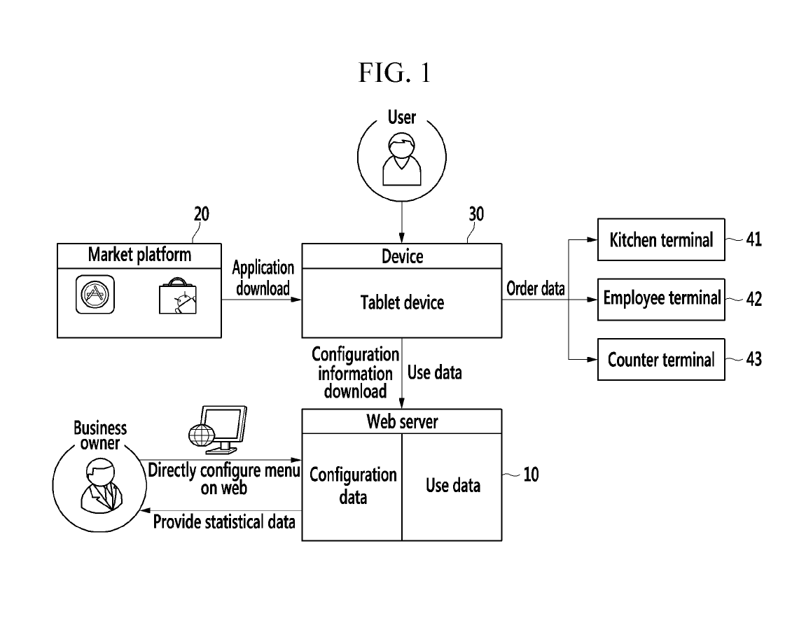

FIG. 1 illustrates a block diagram of an electronic menu book service system using a web editor according to an exemplary embodiment of the present invention.

As shown in FIG. 1, the electronic menu book service system using the web editor according to the present invention includes a web server 10, a market platform 20, a user device 30, a kitchen terminal 41, an employee terminal 42, and a counter terminal 43.

When a user accesses an on-line system, the web server 10 configures and stores an application menu page via a web editor 11 to configure a menu. Further, when the user logs in, the web server 10 downloads configuration information on the menu page to the user device 30. In this case, the user and the web server 10 access a network via the user device 30 or a terminal such as a computer.

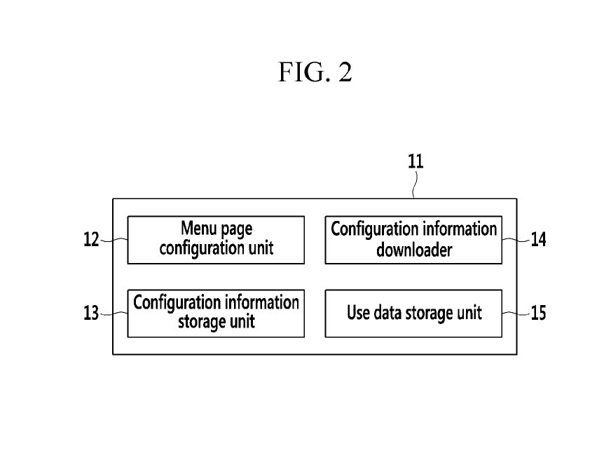

As shown in FIG. 2, the web editor 11 displays a web editing screen to configure the menu page on a browser of the terminal, and includes a menu page configuration unit 12 which configures the menu page in accordance with information inputted by the user through an input device. The menu page configuration unit 12 provides control toolbars of the menu book such as an image, text, a link button, an ordering button, and a pop button, configures the menu page in accordance with user operation of the control toolbars, and displays the configured menu page on a screen depending on execution of a menu application.

In addition, the web editor 11 preferably further includes: a configuration information storage 14 storing the configuration information on the menu page; a configuration information downloader 13 which downloads the configuration information stored in the configuration information storage 14 to the user device 30 connected to the network; and a use data storage 15 in which use data transmitted from the user device 30 is stored and provided in a form of statistical data.

The user device 30 downloads and installs a menu book application via the web server 10 and the market platform 20 connected to the network, and displays the menu book on the screen by downloading the configuration information from the web server 10. The user device 30 is provided for the user at a shop such as a restaurant and displays the electronic menu book on the screen, thereby transmitting menu-related information. In this way, a customer directly operates the electronic menu or an employee operates the electronic menu, thereby inputting and transmitting order information to the user device 30.

Two or more user devices 30 may be prepared at the shop. When two or more user devices are prepared at the shop, the respective user devices 30 download the configuration information by respectively connecting with the web server 10 and then configure the electronic menu book.

Operation of the electronic menu book using the web editor according to the exemplary embodiment of the present invention will now be described in detail.

A business owner running a shop accesses the web server 10 with his/her own terminal such as a computer, a smartphone, etc. via the network so as to configure the electronic menu book of the shop (e.g., a restaurant).

After the business owner successfully accesses the web server 10, the business owner signs up for a membership according to an ordinary membership procedure.

When the business owner who has successfully joined the membership accesses the web server 10, the web server 10 provides the web editor 11 to the business owner, then the business owner freely configures his/her desired electronic menu book.

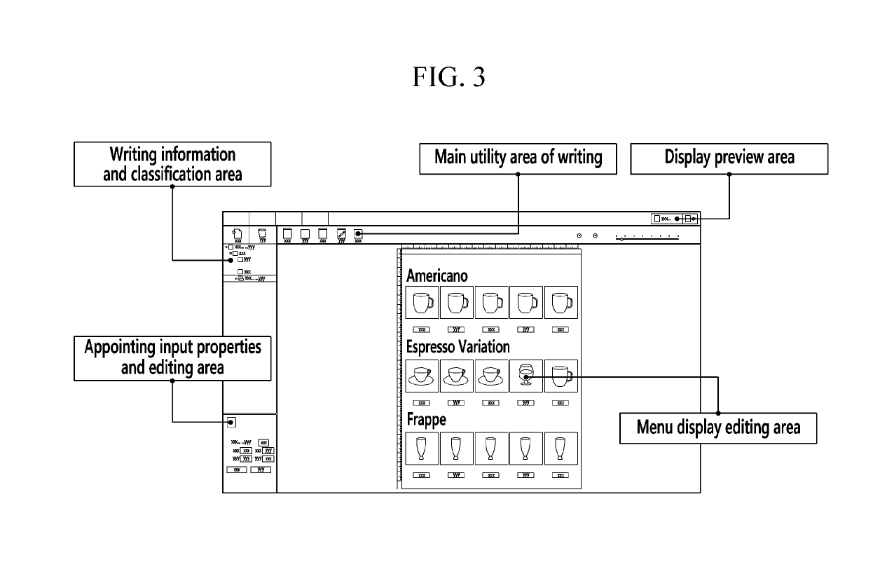

For example, as shown in FIG. 2, the menu page configuration unit 12 of the web editor 11 displays the web editing screen such as shown in FIG. 3 to configure the menu page on the browser of a business owner terminal.

The business owner configures the menu page on the web editing screen as shown in FIG. 3 displayed on the browser of the business owner terminal by using the input device such as a mouse or a keyboard.The web editing screen as shown in FIG. 3 includes: a writing information and classification area for confirming the writing information and classification; an input property appointing and editing area for appointing and editing the input properties; a main utility area of the writing for supporting tools for the writing; a display preview area for previewing the configured menu page; and a menu display editing area for editing the menu.

The business owner selects a template for configuring the electronic menu book so as to configure the menu page. Alternatively, in a default condition without the template, the menu page may be configured by disposing the selected menu and inputting a description in a default page. For example, a method of configuring the menu page includes configuring a menu, selecting an image and a color of a background, adding a function, inserting an image, inputting a description, determining a position of a description font, and configuring a pop-up page button and a pop-up page for an order and page-turning. In this case, the menu, the image and the color of the background, the image, the description, the description font, and menu configuration information such as a menu name and price become the property information of the electronic menu book.

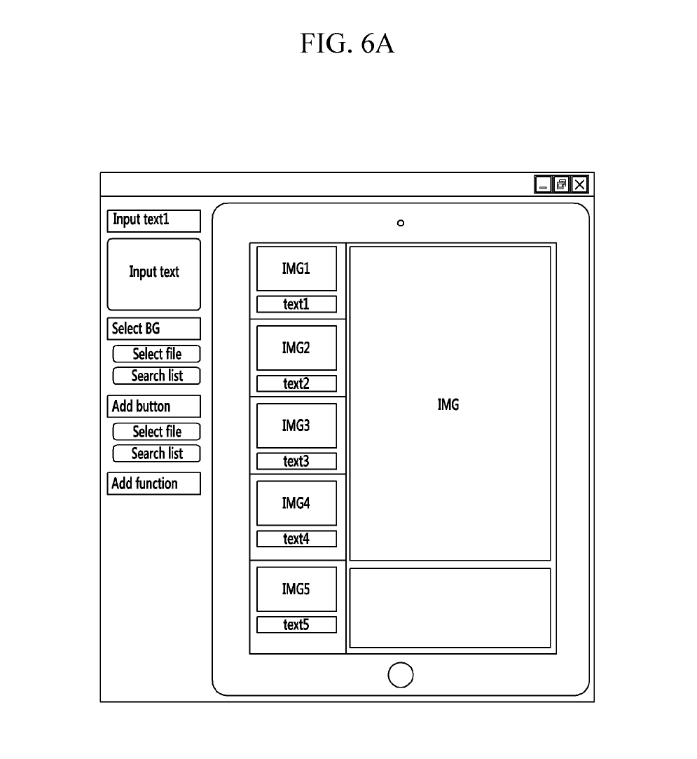

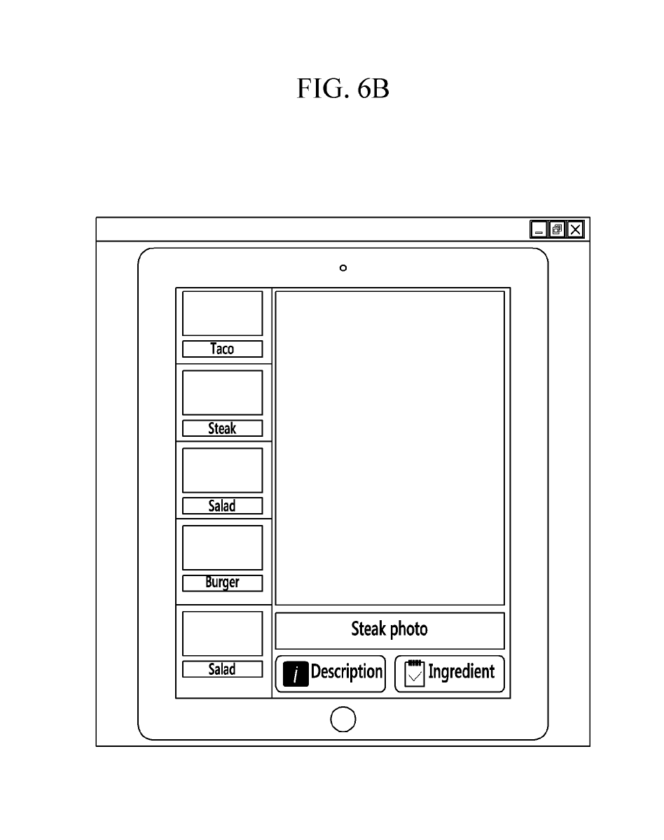

FIG. 6A exemplarily illustrates a template for configuring the menu page, and FIG. 6B illustrates a menu page completed by inserting an image or inputting a description on the template.

Herein, one of the features with respect to a menu page configuration according to the present invention is to diversely change an image location or location of description input by adding functionsFor example, the business owner selects the image location or the location of description input by adding the functions, and freely modifies the provided template or configures contents by inserting the image or inputting the description into the selected location, thereby configuring the personally desired electronic menu book.

A conventional method of configuring the electronic menu book is to only insert the image and input the description into a predetermined location on a premade template, which causes a limit on configuring various types of the electronic menu book. In contrast, the present invention enables the business owner to freely modify the location of the image and description input, and to also change the template formation, thereby providing the business owner with an opportunity to freely configure the electronic menu book.

Since the menu page is directly configured on the Web through the processes described above, a new application is not required to be made as before when the electronic menu book needs to be modified, thereby having advantages of saving a cost for making an application and of shortening a period for making the application.

When the menu page configuration is completed, the menu page configuration unit 12 performs a preview function in accordance with request of the business owner and displays the configured menu page on the screen. As a result, the business owner may carry out a test on the electronic menu book that the business owner himself/herself configured on the web in real time without using his/her own user device 30.

When a test result of the electronic menu book is satisfactory, a save command is inputted. Further, the configuration information storage 14 stores the configuration information on the menu page configuration in accordance with the save command.

Through the processes, the business owner directly configures the menu page on the web and stores the menu page in the web server 10.

After the above-mentioned processes, the business owner accesses the web server 10 or the market platform 20 by using the user device 30 and downloads and installs the application to perform the electronic menu book, so as to use the electronic menu book directly configured on the web server at a business owner shop. Hereinafter, a person using the user device 30 is referred to as a user. However, such the user may be the business owner configuring the menu page on the web server 10, or may be an employee working at the business owner shop.

After installing the electronic menu book application at the user device, the user accesses the web server 10, and then logs in via the network.

After the above-mentioned processes, the menu page configuration information is requested from the web server. According to the request, the configuration information downloader 13 of the web editor 11 downloads the configuration information stored in the database to the user device.

A controller of the user device 30 configures and stores the electronic menu book, and displays the electronic menu book on the screen on the basis of the configuration information downloaded from the web server 10 via the electronic menu book application.

After the above-mentioned process, the user device 30 is used as the menu book and an order terminal.

The user device 30 is located at each table, which enables the customer to directly operate it and place an order. Alternatively, the user himself/herself holds the user device 30 and goes to a table, and lets the customer at the table directly operate it, or the user himself/herself inputs what the customer ordered into the user device instead, or the employee handwrites the order information and then inputs the order information at a counter. As described above, the order process is completed in accordance with the above-mentioned methods.

When the order is completed, the user presses an order data transmitting button, which is an input device. Further, when the order data transmitting button is pressed, the controller of the user device 30 selectively or simultaneously transmits the order data to the kitchen terminal 41 installed at a kitchen, the employee terminal 42 held by the employee, and the counter terminal 43 installed at the counter. In this case, it is assumed that one-way or two-way wireless communications are possible between the user device 30, the kitchen terminal 41, the employee terminal 42, and the counter terminal 43.

In the meantime, according to another feature of the present invention, customer data, which are created by the user device 30, such as customer information and the order information, are transmitted to the web server 10 via the network as use data. The use data storage 15 of the web editor 11 of the web server 10 registers the use data in the database.

In this way, the use data registered on the web server 10 is provided to the business owner terminal as statistical data in accordance with the request of the business owner. The business owner may recognize information on customer preferences and frequently ordered menus based on the statistical data, thereby utilizing the confirmed information as business information.

### Exemplary Embodiment 2

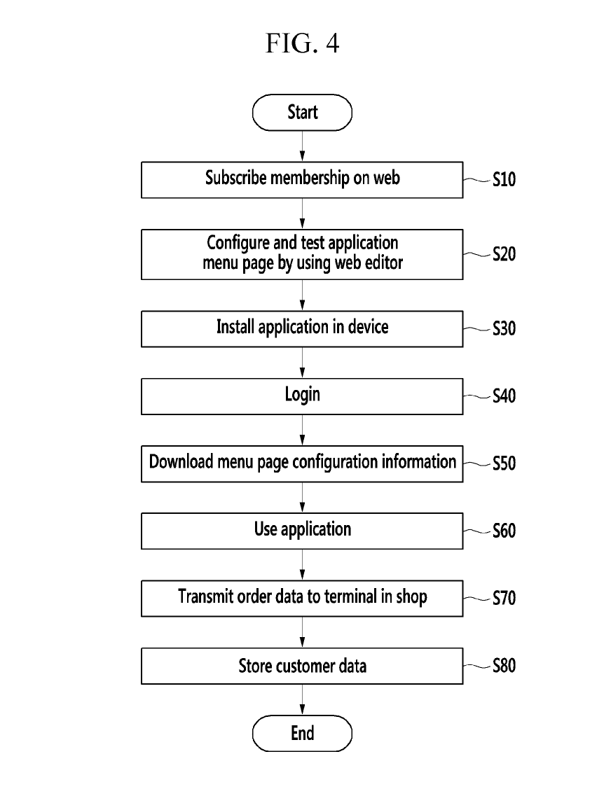

FIG. 4 illustrates a flowchart of an electronic menu book service method of using a web editor according to an exemplary embodiment of the present invention.

As shown in FIG. 4, the electronic menu book service method using the web editor according to the exemplary embedment of the present invention includes: (a) configuring, by the web editor of the web server 10, the application menu page on the web editing screen at steps S10 and S20; (b) installing, by the user device 30, the menu book application at step S30; (c) accessing, by the user device 30, the web server 10 to download the configuration information on the menu page configured on the web at steps S40 and S50; (d) using, by the user device 30, the menu book application at step S60; (e) transmitting, by the user device 30, the order data including the customer order information to the terminal located at a shop at step S70; and (f) storing, by the user device 30, customer data in the web server 10 at step S80.

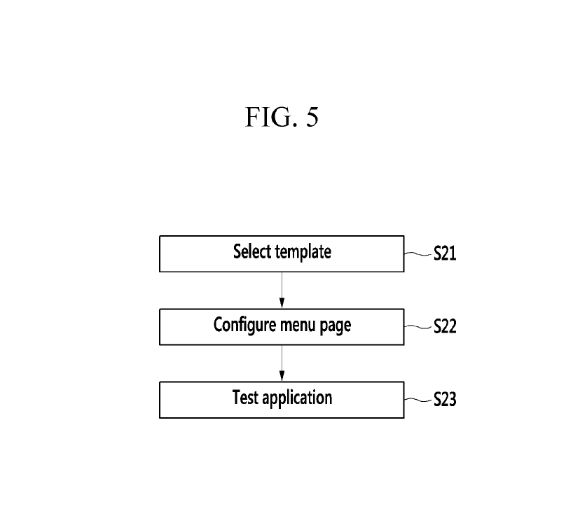

As shown in FIG. 5, the step (a) includes: (a-1) selecting the template for configuring the menu page at step S21; (a-2) configuring the menu page on the selected template at step S22; and (a-3) confirming the configured menu page through the preview function of the menu book at step S23.

Additionally, the step (a-2) includes configuring menus, selecting the image and the color of the background screen, adding the function, inserting the image for the menu, inputting order-related information, inputting the description on the menu, and determining the position font of the description.

The electronic menu book service method using the web editor according to the exemplary embodiment of the present invention will now be described in detail.

First, the business owner signs up for the membership by using his/her own terminal at step S10, so as to directly configure the menu book on the web.

Next, the business owner accesses the web server 10 and configures the application menu page on the web editor screen with the web editor provided from the web server 10 at step S20.

The web editing screen includes a writing information and classification area for confirming the writing information and classification, an input property appointing and editing area for appointing and editing the input properties, a writing main utility area for supporting tools for the writing, a display preview area for previewing the configured menu page, and a menu display editing area for editing the menu.

As shown in FIG. 5, the configuring of the menu page includes: selecting the template for configuring the menu page at step S21; configuring the menu page on the selected template at step S22; and testing the configured menu page by executing the menu book application at step S23. The menu page is configured by the configuring of the menu, the selecting of the image and the color of the background screen, the adding of the function, the inserting of the image for the menu, the inputting of the description on the menu, and the determining of the position of the description font.

When the menu page is configured through the above-mentioned processes, the electronic menu book configured by executing the menu book application on the Web may be tested in real time, and the configuration information on the completely tested menu page is stored in the database of the web server.

Next, the business owner downloads and installs the menu book application by accessing the market platform 20 via the user device 30, so as to use the menu page completed on the web at step S30.

When the menu book application is completely installed, the business owner accesses the web server 10 and logs in through the user device 30 at step S40, and then downloads the configuration information of the menu page configured on the web at step S50. In this case, the configuration information may be downloaded in a form of XML data.

Next, the user performs the menu book application with the user device 30, thereby displaying the electronic menu book configured in the web server on the Web on the screen of the user device 30 at step S60.

Next, the user takes an order by using the electronic menu book displayed on the user device 30. When the customer order is completed, the user transmits the order data with the customer order information to the respective terminals such as the kitchen terminal, the employee terminal, and the counter terminal at step S70. The order data may be preferably transmitted by a near field communication (NFC) method.

Next, the customer data such as customer information, order information, customer requirements, and customer satisfaction rate are stored in the web server 10 through operation of the user device 30 at step S80.

The customer data stored in the web server (10) are transmitted to the business owner terminal in a form of statistical data later. Further, the customer data analyzed by the business owner is utilized as business information and is also used for increasing sales.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

The present invention is applied to service technology of the electronic menu book. Specifically, the electronic menu book may be configured on the web and may be effectively utilized at the user's device.

### DESCRIPTION OF SYMBOLS

10 web server

11 web editor

12 menu page configuration unit

13 configuration information downloader

14 configuration information storage

20 market platform

30 user device

What is claimed is:

1. An electronic menu book service method using a web editor, comprising:
(a) configuring, by a web editor of a web server, an application menu page on a web editor screen;
(b) installing, by a user device, a menu book application thereat;
(c) accessing, by the user device, the web server and downloading configuration information on a menu page configured on the web; and
(d) using, by the user device, the menu book application including the configuration information.

2. The electronic menu book service method using the web editor of claim 1, wherein the step (a) includes: (a-1) selecting a template for configuring the menu page; (a-2) configuring the menu page on the selected template or a non-set initial screen; and (a-3) confirming the configured menu page through a preview function of a menu book.

3. The electronic menu book service method using the web editor of claim 2, wherein the step (a-2) includes: configuring menus; selecting an image and a color of a background screen; adding a function; inserting an image for the menu; inputting a description on the menu; determining a font position of the description; and inputting order-related information.

4. The electronic menu book service method using the web editor of claim 1, wherein the web editing screen includes a writing information and classification area for confirming writing information and classification, an input property appointing and editing area for appointing and editing input properties, a writing main utility area for supporting tools for the writing, a display preview area for previewing the configured menu page, and a menu display editing area for editing the menu.

5. The electronic menu book service method using the web editor of claim 1, further comprising: (e) transmitting, by the user device, order data of a customer to a terminal located at a shop; and (f) storing, by the user device, the order data of the customer in the web server.

6. An electronic menu book service system using a web editor, comprising:
a web server in which an application menu page is configured to be stored with a web editor for configuring a menu when a user accesses the web server via a network, and that downloads configuration information of a menu page to a user device when the user logs in; and
a user device in which a menu book application is downloaded and installed by the web server and a market platform connected to the network, and that receives configuration information of a menu book from the web server and displays the menu book on a screen.

7. The electronic menu book service system using the web editor of claim 6, wherein the web editor displays a web editing screen for configuring the menu page on a browser of the user device, and includes a menu page configuration unit that configures the menu page in accordance with information that a user inputs with an input device.

8. The electronic menu book service system using the web editor of claim 7, wherein the menu page configuration unit provides a template for configuring the menu book, configures the menu page in accordance with an operation of the user, and displays the configured menu page on the screen when the menu book application is executed.

9. The electronic menu book service system using the web editor of claim 7, wherein the web editor includes a configuration information storage that stores the configuration information on the menu page, and a downloader that enables the configuration information stored in the configuration information storage to be downloaded to the user device connected online.

10. The electronic menu book service system using the web editor of claim 9, wherein the web editor includes a use data storage that stores use data transmitted from the user device and provides the use data in a form of statistical data.
